(19) United States
(12) Patent Application Publication
(10) Pub. No.: US 2024/0025122 A1
(43) Pub. Date: Jan. 25, 2024

(54) METHOD FOR ARRANGING SUPPORT STRUCTURES

(71) Applicant: Ivoclar Vivadent AG, Schaan (LI)

(72) Inventors: Alexander SCHÖCH, Schaan (LI); Hendrik JOHN, Buchs (CH)

(21) Appl. No.: 18/355,363

(22) Filed: Jul. 19, 2023

(30) Foreign Application Priority Data
Jul. 21, 2022 (EP) 22186242.8

(51) Int. Cl. B29C 64/386; A61C 13/00; B29C 64/40; B33Y 50/00

(52) U.S. Cl. CPC B29C 64/386; A61C 13/0019; A61C 13/0013; B29C 64/40; B33Y 50/00; B29C 64/124

(57) ABSTRACT

A method for arranging support structures for an additive manufacturing process on a dental restoration, comprising the steps of detecting (S101) a flash line in a digital model of the dental restoration; and adding (S102) support structures to the digital model for supporting the dental restoration in the additive manufacturing process along the flash line.

### CROSS-REFERENCE TO RELATED APPLICATIONS

This application claims priority to European Patent Application No. 22186242.8 filed on Jul. 21, 2022, the disclosure of which is incorporated herein by reference in its entirety.

### TECHNICAL FIELD

The present invention relates to a method for arranging support structures for an additive manufacturing process on a dental restoration and a computer program for carrying out the method.

### BACKGROUND

Current CAM-AM-SW (computer aided manufacturing-additive manufacturing-software) products generate support structures via general algorithms that do not follow dental-specific approaches.

U.S. Pat. No. 11,623,409, 20100042241 and 20210386519 are directed to methods and systems for manufacturing 3D models and products and are hereby incorporated by reference.

### SUMMARY

It is the technical aim of the present invention to provide an automated process for the generation of support structures, in which the support structures are applied to areas of a dental restoration that are not critical from a dental point of view and in which surfaces that are functional from a dental point of view remain intact.

This technical task is solved by subject matter according to the independent claims. Technically advantageous embodiments are the subject matter of the dependent claims, the description and the drawings.

According to a first aspect, the technical task is solved by a method for arranging support structures for an additive manufacturing process on a dental restoration, comprising the steps of detecting a flash line in a digital model of the dental restoration; and adding digital support structures to the digital model for supporting the dental restoration in the additive manufacturing process along the flash line. The flash line of a differentiable surface is characterized by the gradient being perpendicular to one of the two main curvature directions. The curvature in this direction is negative in this case. The process can be used to produce an optimized support structure for bottom-up stereolithography. The method implements an automated process for generating support structures for bottom-up stereolithography depending on the component being 3D printed. The support structure is generated in such a way that it is applied to the dental restoration in areas that are not critical from a dental point of view and that surfaces that are functional from a dental point of view remain intact. In this way, on the one hand a stable construction process is achieved and on the other hand a low effort for post-processing is achieved. This is accomplished by distributing the support structures along the flash line. For this process of generating flash line support structures, the flash lines are automatically detected and generated.

In a technically advantageous embodiment of the method, the digital model is rotated to a predetermined orientation before the flash line is detected. This achieves, for example, the technical advantage that suitable flash lines can be identified.

In another technically advantageous embodiment of the method, a type of dental restoration is determined on the basis of the digital model before the flash line is detected. The dental restoration can be of the type, for example, but not limited to, “bridge”, “splint”, “partial prosthesis” or “full prosthesis”. The type of dental restoration can be determined based on the digital model, for example. A self-learning algorithm that can automatically assign a type to a digital model, such as a neural network, can be used for this purpose. This achieves the technical advantage, for example, that the flash line can be detected depending on the type of dental restoration.

In another technically advantageous embodiment of the method, a predetermined orientation is determined based on the type of dental restoration. Depending on the type of dental restoration, the digital model can be rotated to a predetermined orientation. This provides the technical advantage, for example, that the flash line can be determined more clearly. In addition, the dental restoration can be produced in a suitable orientation and supported with support structures.

In another technically advantageous embodiment of the method, the flash line is determined by a gradient method. This has the technical advantage, for example, that the flash line can be determined in a simple manner.

In another technically advantageous embodiment of the method, a steepest descent on a surface of the digital model is determined based on a local gradient on a surface of the digital model. This achieves the technical advantage, for example, that the flash line can be determined with only a few calculation steps.

In another technically advantageous embodiment of the method, the flash line is determined by detecting local minima in a layer of the digital model. This also achieves the technical advantage, for example, that points along the flash line can be determined in a simple manner.

In another technically advantageous embodiment of the method, the minima are determined in successive layers of the digital model. This has the technical advantage, for example, that the flash line can be determined layer by layer.

In another technically advantageous embodiment, the flash line is determined by means of a self-learning algorithm or watershed method. This has the technical advantage, for example, that the determination of the flash line can be improved by training examples.

In another technically advantageous embodiment of the method, a mutual distance of the support structures along the flash line is determined on the basis of a slope of the flash line. The greater the slope of the flash line, the greater the distance along the flash line between the support structures is selected. This achieves the technical advantage, for example, that the density of support structures can be adjusted according to spatial requirements.

In another technically advantageous embodiment of the method, the support structures are arranged at regular or irregular intervals along the flash line. This achieves the technical advantage, for example, that the flash line can be supported regularly or irregularly.

In another technically advantageous embodiment of the method, the support structures are arranged within a predetermined distance from the flash line. This has the technical advantage, for example, of increasing flexibility in the arrangement of support structures and leaving the flash line untouched by supports in critical areas.

In another technically advantageous embodiment of the method, the dental restoration with the support structures is produced in an additive manufacturing process. This achieves the technical advantage, for example, that the digital model can be produced in a simple manner.

In another technically advantageous embodiment of the method, the additive manufacturing process is a stereolithography process. This achieves the technical advantage, for example, that a particularly suitable manufacturing process is used.

According to a second aspect, the technical task is solved by a computer program comprising instructions that, when the computer program is executed by a computer, cause the computer to execute the method according to the first aspect. The computer program may be executed on a manufacturing device.

In this second aspect, a computer program product comprises computer program code which is stored on a non-transitory machine-readable medium, the machine-readable medium comprises computer instructions executable by a processor, which computer instructions cause the processor to perform the method according to the first aspect.

### BRIEF DESCRIPTION OF THE DRAWINGS

Exemplary embodiments of the invention are shown in the drawings and are described in more detail below, in which:

FIG. 1 shows a view of a digital model of a dental restoration with a flash line;

FIG. 2 shows a schematic view of a gradient method;

FIG. 3 shows a three-dimensional representation of the optimum starting points;

FIG. 4 shows a schematic view of a flash line detection;

FIG. 5 shows several cross-sectional views through the digital model of a dental restoration;

FIG. 6 shows another cross-sectional view through the digital model of a dental restoration;

FIG. 7 shows a view of a digital model of a dental restoration with added support structures; and

FIG. 8 shows a block diagram of a method for arranging support structures on a dental restoration.

### DETAILED DESCRIPTION

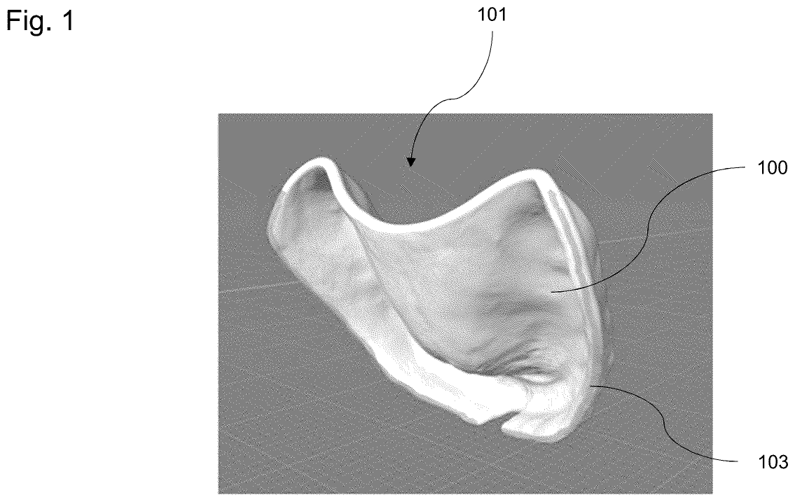

FIG. 1 shows a view of a digital model 101 of a prosthesis base as a dental restoration 100 with a flash line 103. However, the dental restoration 100 can generally also be, a bridge, a splint, or a partial or full prosthesis.

The digital model 101 of the dental restoration 100 represents the spatial shape of a dental restoration 100 to be produced. The digital model 101 may comprise a data set in which the three-dimensional coordinates of the surface of the digital model 101 and other properties are stored. The dental restoration 100 may be produced using an additive manufacturing process based on the digital model 101, such as a 3D printing process.

For example, the dental restoration 100 is built up layer by layer in a stereolithography process. Support structures are used to support the dental restoration 100 to be produced on a construction platform of the manufacturing device. After production, the support structures are removed from the dental restoration 100.

The support structures extend between the construction platform and the dental restoration 100. These support the dental restoration 100 against the construction platform and transfer the separation forces to the construction platform during production.

A flash line 103 can be identified in the dental restoration 100 to be produced. The flash line 103 is characterized by the gradient being perpendicular to one of the two main curvature directions of the surface.

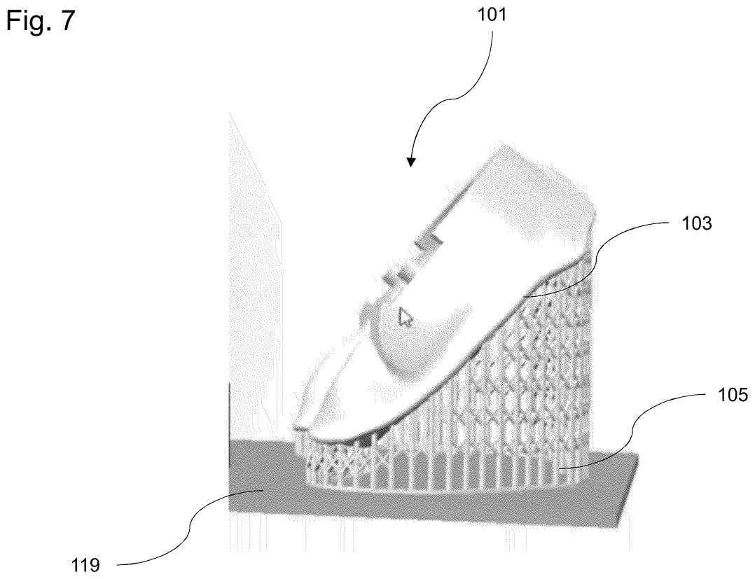

For certain indications, the automatic production of support structures 105 (shown in FIG. 7) along the flash line 103 represents an advantageous method for minimizing the support of functional surfaces in the component. In order to achieve a reasonable support along the flash line 103, the corresponding component can be oriented in a predetermined manner.

Conventional methods are not suitable for targeted support of flash lines 103, since the flash lines 103 often do not exceed a defined critical angle. At the same time, other areas of the digital model 101 whose support is undesirable may have such a high angle that they are supported. To improve this situation, the flash lines 103 are detected in the digital model 101 and then specifically supported with support structures.

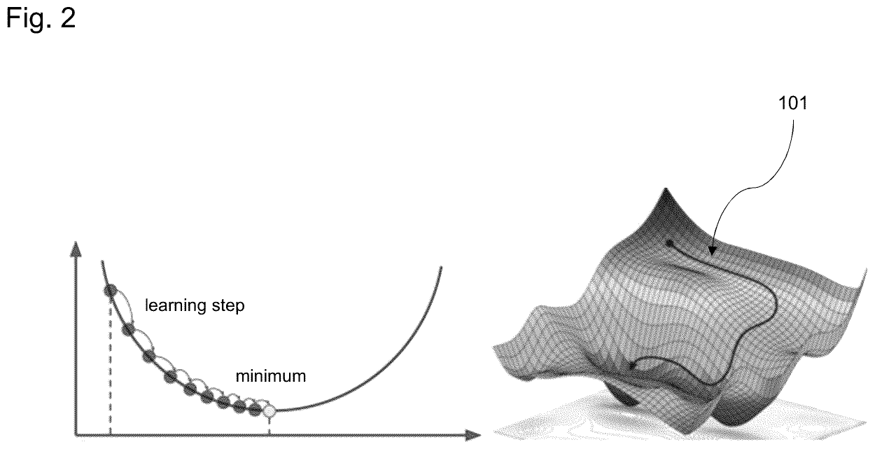

FIG. 2 shows a schematic view of a gradient method for detecting flash lines 103. One possible way to detect flash line 103 may be to use an optimization approach, such as a gradient descent algorithm. Here, step by step, using a local gradient on the surface of the digital model 101, the steepest descent is detected and a step is taken in the direction of the steepest descent. This is repeated with decreasing steps until no more descent occurs or a predetermined number of steps have been performed.

This method thus evaluates a local environment of a starting point, based on which the next step is determined. From a high starting point 107 on the surface progress is made step by step to a local minimum. On the left side a simple example in a 1D function is shown. On the right side a more complex example on a height map.

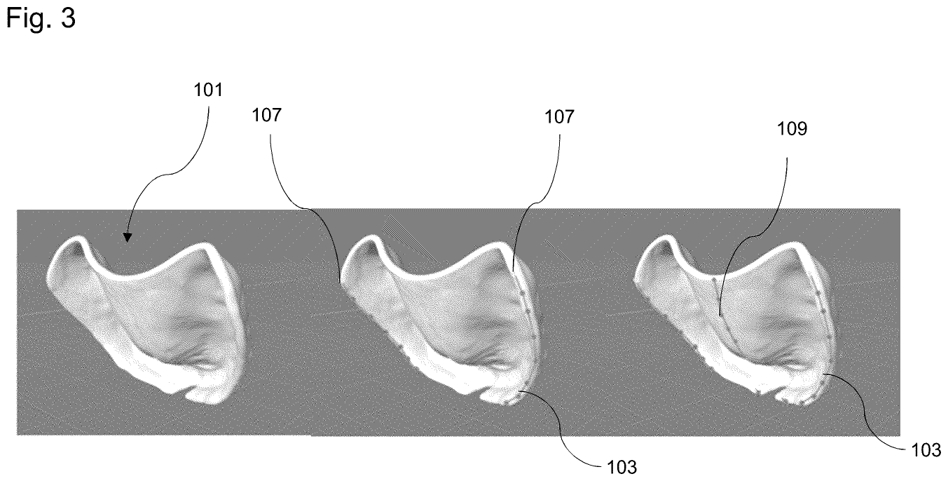

FIG. 3 shows a schematic view of a detection of a flash line 103. The result shows not only the local minimum found, but the entire distance traveled. With an appropriately selected starting point 107 on the digital model 101, the gradient method follows the flash line 103, since the steepest descent occurs along it. Therefore, the starting points 107 in the gradient method are initially selected accordingly. As the steps in the gradient method become smaller and smaller, the resulting path for the arrangement of the support structures is resampled. The digital model 101 of a prosthesis base is shown on the left. In the center, the starting points 107 for the gradient method and the determined flash line 103 are shown. On the right side, additional local minima and a centerline 109 along the palatal region are shown.

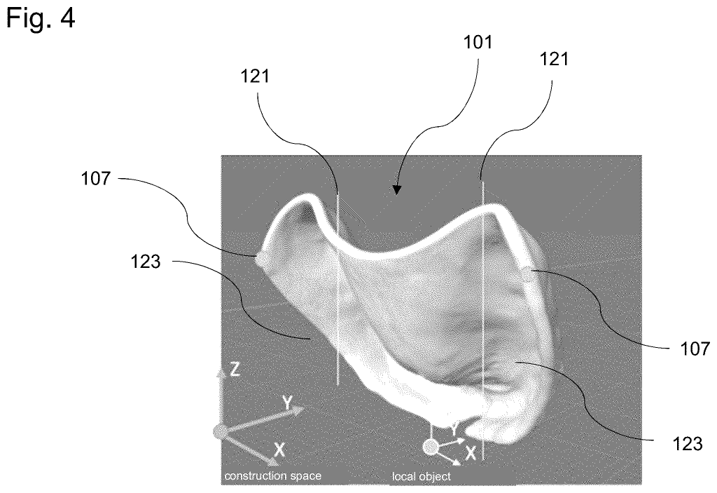

FIG. 4 shows a three-dimensional representation of the optimal starting points 107 in edge regions 123. Determination of the starting point 107 for the gradient descent method can be done by user interaction or automated. In user interaction, a user clicks on the model surface to manually select a starting point 107. Alternatively, automation may be performed, for example, by searching the global minima in the Y-direction at defined edge regions (in the X-direction) of the digital model 101 by aligning the digital model 101 so that the local XY-axes are identical to those of the construction space. Then, edge regions are defined, such as 20% of the span in the X direction with the boundary line 121. For each edge region, the global minimum in the Y direction is searched, this point on the surface represents a starting point 107. The boundary of the edge regions is shown as boundary line 121.

The same process for determining starting points can be used for the approach using local minima in layer data. Considered per starting point, the method begins on the layer where the global minimum was found or on the layer where the starting point chosen by the user is located.

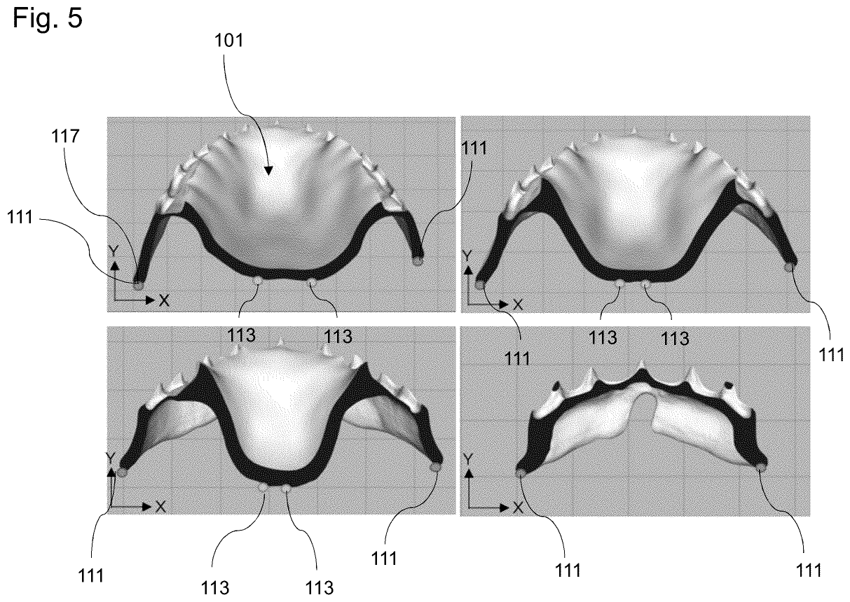

FIG. 5 shows several cross-sectional views through the digital model 101 of a dental restoration 100. The flash line 103 can also be detected in layer data based on local minima 117. This layer data is given by sections through the digital model 101. The layer data is obtained at different heights in the digital model 101. Once the orientation of the dental restoration 100 about the Z axis is known, the positions of the flash line 103 can be found by analyzing the local minima 117 in a layer. The flash line 103 is determined by detecting and lining up local minima in layers of the digital model 101 parallel to the construction plane.

The dental restoration 100 is aligned so that its local XY axes are identical to the axis of the construction space. The points 111 represent local minima 117 at the flash line 103. The points 113, on the other hand, are local minima which are located in the palatal region and should be excluded.

On the example shown, the minima 117 at flash line 103 can be easily identified by sorting along the X axis. These are the minima 117 at points 111 with minimum and maximum X coordinate. For digital models 101 of other restorations, filtering of the layer data can take place to ignore minima 117 in areas of high frequency and/or small amplitude.

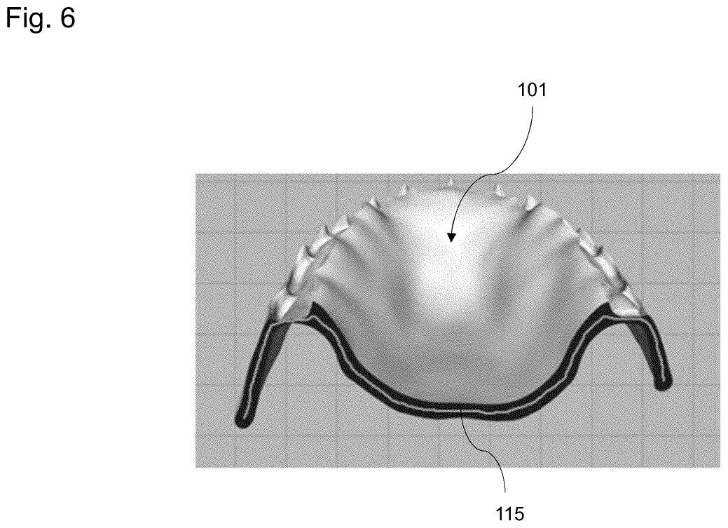

FIG. 6 shows another cross-sectional view through the digital model 101 of a dental restoration 100. For easier detection of the minima 117, the areas of the layer data can be transformed to lines 115 using skeletonization, for example.

FIG. 7 shows a view of a digital model 101 of a dental restoration 100 with added support structures 105. The support structures 105 are used to support the digital model 101 along the flash line 103 on the construction platform 119.

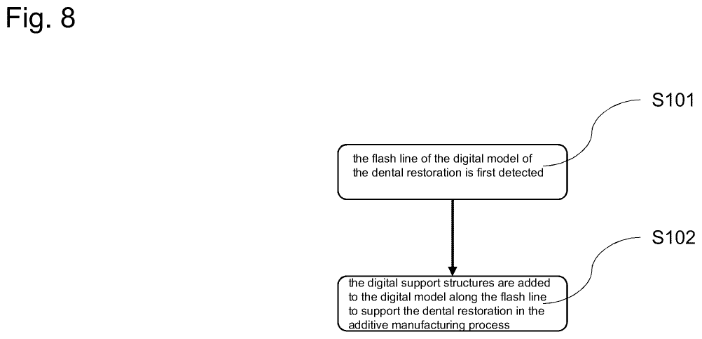

FIG. 8 shows a block diagram of a method for arranging support structures 105 for an additive manufacturing process on the dental restoration 100. In step S101, the flash line 103 of the digital model 101 of the dental restoration 100 is first detected. Then, in step S102, the digital support structures 105 are added to the digital model 101 along the flash line 103 to support the dental restoration 100 in the additive manufacturing process. The spacing of a grid of the support structures in the construction plane or construction platform may be constant.

The support structures 105 and their contact points on the dental restoration 100 can be determined using the layer data based on bitmaps or a vector representation. The support structures 105 are determined individually for each dental restoration 100. The dental restorations 100 should be available in a component-specific or indication-specific orientation in the coordinate system. In order to align the dental restorations 100, the dental restorations 100 can be recognized on the basis of the spatial shape in special software and then automatically oriented. This allows the correct flash lines for the supports to be identified more quickly by the selected algorithm.

For example, the occlusal side points away from the construction platform, i.e., it is distal to the construction platform. The labial side points in the +X direction or −X direction. The component is then adjusted at an angle of 30° to 90° so that the occlusal side points in the −X direction.

First, the local minima 117 of the dental restoration 100 are determined, which are provided with support structures 105 in any case. To generate support structures 105 along the flash line 103, the dental restoration 100 is then sliced and raster graphics (bitmaps) are generated from the individual layers. Here, the respective layers are traversed in the XY plane in the Z direction from the bottom, i.e. the surface of the construction platform, to the top, i.e. away from the surface of the construction platform. Isolated cross-sectional areas with trailing cross-sectional areas are identified as local minima 117 in the following layer. The cross-sectional areas of the dental restoration 100 are examined in the layer contrary to the X-direction (i.e., in the −X-direction) for local minima 117. From the opposite direction, these local minima 117 in the X direction can be interpreted as peaks.

Now corresponding XYZ coordinates can be assigned to the local minima found in the X direction on the basis of the known layer distance. These coordinates indicate the contact point of the flash line 103 on the surface of the dental restoration 100. The flash line 103 is detected by connecting the found and directly adjacent points of the local minima 117 across all layers. The flash line 103 is thus created by connecting the nearby minima in the successive layers. If the local minima 117 found in this way are provided with support structures 105 in the X direction, a curtain of support structures 105 is created.

A peak finder algorithm can also be applied to the bitmap data, which finds corresponding peaks as minima in the bitmaps. In this case, a distinction can be made between larger (major) and smaller (minor) peaks. Otherwise, the flash line 103 can also be detected by means of a self-learning algorithm that has learned the course of the flash line 103 from a plurality of training examples. The training examples here are formed by digital models 101 of dental restorations 100 in which the course of the flash line 103 is predetermined. However, the flash line 103 can also be detected by a watershed method. Here, for example, the segmentation of a topographic surface of a gray-scale image by watersheds corresponds to the division of the image plane into disjoint catch basins.

If level curves are placed in the digital model along the XY plane (outer contours in the layers), linking the convex vertices in the adjacent level curves gives the flash line 103 and linking the concave vertices in the adjacent level curves gives the valley line.

If discrete support structures 105 are to be placed, the mutual distance of the support structures 105 along the flash line 103 can be determined as a function of the slope of the flash line, the steeper the greater the distance along the flash line 103. The support structures 105 can also be arranged at a predetermined distance laterally of the flash line 103, i.e., in a strip along the flash line 103.

By creating support structures 105 along the flash line 103 in this manner, other areas (except locations with local minima and critical overhangs) are kept largely free of support structures 105. The dental restoration 100 is optimally supported and a dental technician has minimal effort for post-processing.

In addition, the flash line 103 in the digital model 101 can be smoothed. This is permitted, for example, in a limited range below the pixel/voxel resolution of the 3D printer, since the shape of the dental restoration 100 is maintained.

The method automatically identifies the folds of the dental restoration 100 and arranges support structures 105 along the flash line 103. For this purpose, the dental restoration 100 can be previously assigned to a type for which support structure generation along a flash line 103 can be efficiently used. For example, the dental restoration may be of the type “bridge”, “splint”, “partial prosthesis” or “full prosthesis”.

The method of arranging support structures 105 on the dental restoration 100 may be performed on a computer having a processor and a digital memory. In this case, the processor processes a computer program that is stored in the digital memory with further data. The digital model 101 of the dental restoration 100 is also stored in the memory of the computer. The computer may also be part of a manufacturing device, such as a 3D printer.

All of the features explained and shown in connection with individual embodiments of the invention may be provided in different combinations in the subject matter of the invention to simultaneously realize their beneficial effects.

All process steps can be implemented by devices which are suitable for executing the respective process step. All functions that are executed by the features in question can be a process step of a process.

The scope of protection of the present invention is given by the claims and is not limited by the features explained in the description or shown in the figures.

### REFERENCE SIGN LIST

100 Dental restoration
101 Digital model
103 Flash line
105 Digital support structures
107 Starting point
109 Center line
111 Point
113 Point
115 Line
117 Minimum
119 Construction platform
121 Boundary line
123 Edge regions

1. A method for arranging support structures (105) for an additive manufacturing process on a dental restoration (100), comprising the steps of:
detecting (S101) a flash line (103) in a digital model (101) of the dental restoration (100); and
adding (S102) digital support structures (105) to the digital model (101) for supporting the dental restoration (100) in the additive manufacturing process along the flash line (103).

2. The method according to claim 1, wherein the digital model (101) is rotated to a predetermined orientation prior to detecting the flash line (103).

3. The method according to claim 1, wherein a type of dental restoration (100) is determined based on the digital model (101) prior to detecting the flash line (103).

4. The method of claim 3, wherein a predetermined orientation is determined based on the type of dental restoration (100).

5. The method according to claim 1, wherein the flash line (103) is determined by a gradient method.

6. The method of claim 5, wherein a steepest descent on a surface of the digital model (101) is determined based on a local gradient on a surface of the digital model (101).

7. The method according to claim 1, wherein the flash line (103) is determined by detecting local minima (117) in a layer of the digital model (101).

8. The method of claim 7, wherein the minima (117) are determined in successive layers of the digital model (101).

9. The method according to claim 1, wherein the flash line (103) is determined using a self-learning algorithm or a watershed method.

10. The method according to claim 1, wherein a mutual distance of the support structures (105) along the flash line (103) is determined based on a slope of the flash line (103).

11. The method according to claim 1, wherein the support structures (105) are arranged at regular or irregular intervals along the flash line (103).

12. The method according to claim 1, wherein the support structures (105) are arranged within a predetermined distance from the flash line (103).

13. The method according to claim 1, wherein the dental restoration (100) with the support structures (105) is produced in an additive manufacturing process.

14. The method of claim 13, wherein the additive manufacturing process is a stereolithography process.

15. A computer program product comprising computer program code which is stored on a non-transitory machine-readable medium, the machine-readable medium comprising computer instructions executable by a processor, which computer instructions cause the processor to perform the method according to claim 1.
